(19) United States
(12) Patent Application Publication
(10) Pub. No.: US 2008/0074621 A1
(43) Pub. Date: Mar. 27, 2008

(54) Micro-mirror device with selectable rotational axis

(76) Inventors: Hirotoshi Ichikawa, Tokyo (JP); Fusao Ishii, Menlo Park, CA (US); Yoshihiro Maeda, Tokyo (JP)

Correspondence Address: BO-IN LIN, 13445 MANDOLI DRIVE, LOS ALTOS HILLS, CA, 94022, US

(21) Appl. No.: 11/893,878

(22) Filed: Aug. 16, 2007

Related U.S. Application Data
(60) Provisional application No. 60/839,612, filed on Aug. 23, 2006.

(51) Int. Cl. G03B 21/28; G02B 26/08; G03B 21/26

(52) U.S. Cl. 353/37; 353/99; 359/298

(57) ABSTRACT

A mirror device includes a controller to control and operate a changeover of the direction of the deflection axis of a mirror and/or the deflection direction thereof. And a display apparatus includes at least one of the mirror devices for modulating and reflecting a display image from the mirror devices.

### CROSS REFERENCE TO RELATED APPLICATIONS

This application is a Non-provisional application of a Provisional Application 60/839,612 filed on Aug. 23, 2006. The Provisional Application 60/834,119 is a Continuation in Part (CIP) Application of a pending U.S. patent application Ser. Nos. 11/121,543 filed on May 4, 2005. The application Ser. No. 11/121,543 is a Continuation in part (CIP) Application of three previously filed Applications. These three Applications are Ser. No. 10/698,620 filed on Nov. 1, 2003, Ser. No. 10/699,140 filed on Nov. 1, 2003, and Ser. No. 10/699,143 filed on Nov. 1, 2003 by one of the Applicants of this patent application. The disclosures made in these patent applications are hereby incorporated by reference in this patent application.

### BACKGROUND OF THE INVENTION

1. Field of the Invention

The present invention relates to a mirror device and a display apparatus comprising the mirror device. More particularly, this invention relates to a mirror device that allows flexibility of a selection of the deflection axis of a mirror and/or that of the deflection direction of the mirror and further relates to a display apparatus comprising the mirror device.

2. Description of the Related Art

Even though there are significant technological advances made in implementing an electromechanical mirror device as a spatial light modulator (SLM) for image display systems in recent years, there are still limitations and difficulties when it is employed to provide a high quality image. Specifically, when the images are digitally controlled according to the binary ON-OFF states, the image quality is adversely affected due to the fact that the images are not displayed with sufficient number of gray scales.

An electromechanical mirror device is drawing a considerable interest as a spatial light modulator (SLM). The electromechanical mirror device includes a “mirror array” by arranging and controlling a large number of micromirror elements. In general, the number of the micromirror elements ranges from 60,000 to several millions of pieces and these micromirrors are arranged on a surface of a substrate that is applied to manufacture and support the electromechanical mirror device.

Referring to FIG. 1A, an image display system 1 including a screen 2 is disclosed in a reference U.S. Pat. No. 5,214,420. A light source 10 is used for generating light energy for illuminating the screen 2. The generated light 9 is further concentrated and directed toward a lens 12 by a mirror 11. Lenses 12, 13 and 14 form a beam columnator operative to columnate light 9 into a column of light 8. A spatial light modulator (SLM) 15 is controlled on the basis of data input by a computer 19 via a bus 18 and selectively redirects the portions of light from a path 7 toward an enlarger lens 5 and onto screen 2. The SLM 15 has a mirror array arranging switchable reflective elements 17, 27, 37, and 47 being consisted of a mirror 33 connected by a hinge 30 on a surface 16 of a substrate in the electromechanical mirror device as shown in FIG. 1B. When the element 17 is in one position, a portion of the light from the path 7 is redirected along a path 6 to lens 5 where it is enlarged or spread along the path 4 to impinge on the screen 2 so as to form an illuminated pixel 3. When the element 17 is in another position, the light is not redirected toward screen 2 and hence the pixel 3 is dark.

Each of mirror elements includes a mirror device that comprises a mirror and electrodes are to function as spatial light modulator (SLM). A voltage applied to the electrodes to generate a coulomb force between the mirror and the electrodes to control and incline the mirror. The mirror is “deflected” according to a common term used in this specification for describing the operational condition of a mirror element.

In controlling a mirror, a voltage is applied to the electrode(s) for deflecting the mirror and the deflected mirror also changes the direction of the reflected light in reflecting an incident light. The direction of the reflected light is changed in response to the deflection angle of the mirror. Specifically, the mirror is controlled to operate at an ON state when a light for image display is projected in almost the entirety of an incident light to a projection path designated for image display. The mirror is operated at an OFF state when a light is reflected to a direction away from the designated projection path for image display.

As the mirror reflects only a portion of an incident light to a projection path such that the light reflected has a smaller quantity of light than the state of the ON light. The mirror operated at an intermediate state and the light reflected form the mirror is referred to as an “intermediate light”.

The terminology of present specification further defines an angle of rotation along a clockwise (CW) direction as a positive (+) angle and an angle of rotation along a counterclockwise (CCW) direction as a negative (−) angle. A deflection angle is defined as zero degree (0°) when the mirror is in the initial state parallel to the surface of the substrate, as a reference of mirror deflection angle.

Most of the conventional image display devices such as the devices disclosed in U.S. Pat. No. 5,214,420 implements a dual-state mirror control that controls the mirrors in a state of either ON or OFF. The quality of an image display is limited due to the limited number of gray scales. Specifically, in a conventional control circuit that applies a PWM (Pulse Width Modulation), the quality of the image is limited by the LSB (least significant bit) or the least pulse width as control related to the ON or OFF state. Since the mirror is controlled to operate in either the ON or OFF state, the conventional image display apparatus has no way to provide a pulse width for controlling the mirror that is shorter than the controllable duration that is allowable on the basis of the LSB. The least quantity of light, which is determined on the basis of the gray scale, is the light reflected during the time duration based on the least pulse width. The limited number of gray scales leads to a degradation of the quality of the display image.

Specifically, FIG. 1C exemplifies a control circuit for controlling a mirror element according to the disclosure in the U.S. Pat. No. 5,285,407. The control circuit includes a memory cell 32. Various transistors are referred to as “M*” where “*” designates a transistor number and each transistor is an insulated gate field effect transistor. Transistors M5 and M7 are p-channel transistors; while transistors M6, M8, and M9 are n-channel transistors. The capacitances C1 and C2 represent the capacitive loads in the memory cell 32. The memory cell 32 includes an access switch transistor M9 and a latch 32a, which is based on a Static Random Access Memory (SRAM) design. The transistor M9 connected to a Row-line receives a DATA signal via a Bit-line. The memory cell 32 written data is accessed when the transistor M9, which has received the ROW signal on a Word-line, is turned on. The latch 32a includes two cross-coupled inverters, i.e., M5/M6 and M7/M8, which permit two stable states, that is, a state 1 is Node A high and Node B low, and a state 2 is Node A low and Node B high.

The mirror is driven by a voltage applied to the landing electrode abutting a landing electrode and is held at a predetermined deflection angle on the landing electrode. An elastic “landing chip” is formed at a portion on the landing electrode, which makes the landing electrode contact with mirror, and assists the operation for deflecting the mirror toward the opposite direction when a deflection of the mirror is switched. The landing chip is designed as having the same potential with the landing electrode, so that a shorting is prevented when the landing electrode is in contact with the mirror.

Each mirror formed on a device substrate has a square or rectangular shape and each side has a length of 10 to 15 μm. In this configuration, a reflected light that is not controlled for purposefully applied for image display is inadvertently generated by reflections through the gap between adjacent mirrors. The contrast of an image display generated by adjacent mirrors is degraded due to the reflections generated not by the mirrors but by the gaps between the mirrors. As a result, a quality of the image display is worsened. In order to overcome such problems, the mirrors are arranged on a semiconductor wafer substrate with a layout to minimize the gaps between the mirrors. One mirror device is generally designed to include an appropriate number of mirror elements wherein each mirror element is manufactured as a deflectable mirror on the substrate for displaying a pixel of an image. The appropriate number of elements for displaying image is in compliance with the display resolution standard according to a VESA Standard defined by Video Electronics Standards Association or television broadcast standards. In the case in which the mirror device has a plurality of mirror elements corresponding to WXGA (resolution: 1280 by 768) defined by VESA, the pitch between the mirrors of the mirror device is 10 μm and the diagonal length of the mirror array is about 0.6 inches. The control circuit as illustrated in FIG. 1C controls the mirrors to switch between two states and the control circuit drives the mirror to deflect to either the ON or OFF deflected angle (or position) as shown in FIG. 1A. The minimum quantity of light controllable to reflect from each mirror element for image display, i.e., the resolution of gray scale of image display for a digitally controlled image display apparatus, is determined by the least length of time that the mirror is controllable to hold at the ON position. The length of time that each mirror is controlled to hold at an ON position is in turn controlled by multiple bit words. FIG. 1D shows the “binary time periods” in the case of controlling an SLM by four-bit words. As shown in FIG. 1D, the time periods have relative values of 1, 2, 4, and 8 that in turn determine the relative quantity of light of each of the four bits, where the “1” is the least significant bit (LSB) and the “8” is the most significant bit. According to the PWM control mechanism, the minimum quantity of light that determines the resolution of the gray scale is a brightness controlled by using the “least significant bit” for holding the mirror at an ON position during the shortest controllable length of time.

In a simple example with n-bit word for controlling the gray scale, one frame time is divided into (2ⁿ−1) equal time slices. If one frame time is 16.7 msec., each time slice is 16.7/(2ⁿ−1) msec. Having set these time lengths for each pixel in each frame of the image, the quantity of light in a pixel which is quantified as “0” time slices is black (the non-quantity of light), “1” time slice is the quantity of light represented by the LSB, and 15 time slices (in the case of n=4) is the quantity of light represented by the maximum brightness. Based on the light being quantified, the time of mirror being held at the ON position during one frame period is determined by each pixel. Thus, each pixel with a quantified value which is more than “0” time slice is displayed for the screen by the mirror being held at the ON position with the number of time slices corresponding to its quantity of light during one frame period. The viewer's eye integrates the brightness of each pixel such that the image is displayed as if the image were generated with analog levels of light.

For controlling deflectable mirror devices, the PWM calls for the data to be formatted into “bit-planes”, where each bit-plane corresponds to a bit weight of the quantity of light. Thus, when the brightness of each pixel is represented by an n-bit value, each frame of data has the n-bit planes. Then, each bit-plane has a “0” or “1” value for each mirror element. In the PWM described in the preceding paragraphs, each bit-plane is independently loaded and the mirror elements are controlled on the basis of bit-plane values corresponding to them during one frame. For example, the bit-plane representing the LSB of each pixel is displayed as a “1” time slice.

When adjacent image pixels are displayed with a very coarse gray scales caused by great differences of quantity of light, thus, artifacts are shown between these adjacent image pixels. That leads to the degradations of image qualities. The degradations of image qualities are specially pronounced in bright areas of image when there are “bigger gaps” of gray scale, i.e. quantity of light, between adjacent image pixels. The artifacts are caused by a technical limitation that the digitally controlled image does not obtain a sufficient number of gray scales, i.e. the levels of the quantity of light.

The mirrors are controlled either at the ON or OFF position. Then, the quantity of light of a displayed image is determined by the length of time each mirror is held, which is at the ON position. In order to increase the number of levels of the quantity of light, the switching speed of the ON and OFF positions for the mirror must be increased. Therefore the digitally control signals need be increased to a higher number of bits. However, when the switching speed of the mirror deflection is increased, a stronger hinge for supporting the mirror is necessary to sustain a required number of switches of the ON and OFF positions for the mirror deflection. Furthermore, in order to drive the mirrors provided with a strengthened hinge to the ON or OFF positions, applying a higher voltage to the electrode is required. The higher voltage may exceed twenty volts and may even be as high as thirty volts. The mirrors produced by applying the CMOS technologies probably is not appropriate for operating the mirror at such a high range of voltages, and therefore the DMOS mirror devices may be required. In order to achieve a control of a higher number of gray scales, a more complicated production process and larger device areas are required to produce the DMOS mirror. Conventional mirror controls are therefore faced with a technical problem that the good accuracy of gray scales and range of the operable voltage have to be sacrificed for the benefits of a smaller image display apparatus.

There are many patents related to the control of quantity of light. These patents include the U.S. Pat. Nos. 5,589,852, 6,232,963, 6,592,227, 6,648,476, and 6,819,064. There are further patents and patent applications related to different sorts of light sources. These patents include the U.S. Pat. Nos. 5,442,414, 6,036,318 and Application 20030147052. Also, The U.S. Pat. No. 6,746,123 has disclosed particular polarized light sources for preventing the loss of light. However, these patents or patent applications do not provide an effective solution to attain a sufficient number of the gray scales in the digitally controlled image display system.

Furthermore, there are many patents related to a spatial light modulation that includes the U.S. Pat. Nos. 2,025,143, 2,682,010, 2,681,423, 4,087,810, 4,292,732, 4,405,209, 4,454,541, 4,592,628, 4,767,192, 4,842,396, 4,907,862, 5,214,420, 5,287,096, 5,506,597, and 5,489,952. However, these inventions do not provide a direct solution for a person skilled in the art to overcome the above-discussed limitations and difficulties.

In view of the above problems, an invention has disclosed a method for controlling the deflection angle of the mirror to express higher number of gray scales of an image in a US Patent Application 20050190429. In this disclosure, the quantity of light obtained during the oscillation period of the mirror is about 25% to 37% of the quantity of light obtained during the mirror is held on the ON position at all times.

According to such control, it is not particularly necessary to drive the mirror at high speed. Also, it is possible to provide a higher number of the gray scale using a low elastic constant of the hinge that supports the mirror. Hence, such control makes it possible to reduce the voltage applied to the landing electrodes.

An image display apparatus using the mirror device described above is broadly categorized into two types, i.e. a single-plate image display apparatus equipped with only one spatial light modulator and a multi-plate image display apparatus equipped with a plurality of spatial light modulators. In the single-plate image display apparatus, a color image is displayed by changing in turn the colors, i.e. frequency or wavelength of projected light is changed by time. In a multi-plate the image display apparatus, a color image displayed by allowing the spatial light modulators corresponding to beams of light having different colors, i.e. frequencies or wavelengths of the light, to modulate the beams of light; and combined with the modulated beams of light at all times. The U.S. Pat. No. 4,969,730 has disclosed an example of optical configuration of a multi-plate optical system using a reflective spatial light modulator. Here, when using a conventional mirror device as spatial light modulator in the optical configuration of the U.S. Pat. No. 4,969,730, a problem occurs. The mirror of the mirror device described above is generally configured to make a reflection light reflected on the mirror incident to the iris of a projection lens perpendicularly to a substrate. Also, for reducing an influence of a diffraction light generated by a mirror, the positional relationship of the incident light to the mirror with the deflection axis of the mirror is set in a manner that the incident light is perpendicular to the deflection axis and incident to the mirror surface from a diagonal direction. That is, the configuration is to make the deflection axis of the mirror perpendicular to the incident light and place each of the mirrors rotating 45° in the same plane so as to make it a diamond shape facing the incident light. Such configured conventional mirror device, however, has the deflection axis thereof fixed and therefore only two deflection direction of the mirror available for a choice. As a result, adopting the optical configuration noted above, an additional light path must be provided, inconveniently losing the advantage of its simple optical configuration. Consequently, the conventional mirror device has the deflection axis of the mirror fixed and provides only two deflecting direction of the mirror available for a choice, hence imposing a remarkable limitation in configuring the optical system for a multi-plate display apparatus. FIG. 2A is an image display apparatus disclosed in the U.S. Pat. No. 5,638,142. The display apparatus shown in FIG. 2A has an optical configuration eliminating a necessity of changing the deflection axis and deflection direction of the mirror in a mirror device by lining up the number of reflection of light. The projection principle of the optical configuration 100 shown in FIG. 2A is described here. The light emitted from the light source 101 is incident, at an angle no smaller than the critical angle, to the first prism 103 of the total internal reflection prism by way of the condenser optical system 102. The incident light is totally reflected on the first prism 103 of the total internal reflection prism and incident to the dichroic prism 120. Then, the light possessing the wavelength of blue is spectroscopically separated (noted simply as “separated” hereinafter) from the incident light including the light of a plurality of wavelengths by the first prism 104 of the dichroic prism 120, followed by the light possessing the wavelength of red is likewise separated therefrom in the second prism 108 and by the transmitted light (i.e., the light possessing the wavelength of green), other than the lights of the wavelengths of blue and red, proceeding to the third prism 106. Then, the lights separated into the wavelengths of respective colors are incident to the spatial light modulators 105, 107 and 109, which are assigned to the lights of respective colors, placed on the side face of the dichroic prism 120. The individual spatial light modulators 105, 107 and 109 modulate the lights of the incident respective colors based on the image signal corresponding to the respective colors and reflect the modulated lights of the respective colors again to the dichroic prism 120. The lights of individual colors which are returned by being modulated and reflected by the respective spatial light modulators 105, 107 and 109 are synthesized by the dichroic prism 120, and the synthesized light is incident to the second prism 110 of the total internal reflection prism at an angle no larger than the critical angle. Then, having transmitted through the second prism 110 of the total internal reflection prism, the synthesized light is projected onto a screen by way of the projection lens 111. Here, assumed is an image 112 viewed from the direction of line of sight 201 in the case of using a mirror device as the spatial light modulators 105, 107 and 109. Note that FIGS. 2A and 2B indicate the first, second, third and fourth quadrants of an image by I, II, III and IV, respectively.

FIG. 2B shows the individual images 112B, 112G and 112R when viewing the individual mirror devices 105, 107 and 109 from the respective directions of line of sight 202, 203 and 204. FIG. 2B shows the individual mirrors 105a, 107a and 109a of the respective mirror devices 105, 107 and 109, which generate the ON light, as approximate square, with the apexes of four corners of each mirror indicated as 1, 2, 3 and 4. It also shows a part of the mirror inclining downward by a black solid and the part inclining upward by white. It also shows the mirror device 105, as “B”, corresponding to the light of the wavelength of blue which is separated in the first prism 104 of the dichroic prism 120; the mirror device 109, as “R”, corresponding to the light of the wavelength of red which is separated in the second prism 108; and the mirror device 107, as “G”, corresponding to the light other than the lights of wavelengths of blue and red (i.e., the light of the wavelength of green) in the third prism 106. FIG. 2B shows the images 112B, 112G and 112R at the respective mirror devices 105, 107 and 109 as well as the approximate squares 105a, 107a and 109a indicating the respective mirrors of the mirror devices 105, 107 and 109 by overlapping them, respectively.

The upper row of FIG. 2B shows the mirrors 105a, 107a and 109a of the respective mirror devices 105, 107 and 109 with the deflection axis being 1-4; The lower row of FIG. 2B shows the mirrors 105a-1, 107a-1 and 109a-1 of the respective mirror devices 105, 107 and 109 with the deflection axis being 5-6. In FIG. 2A, when the light of the wavelength of blue is reflected on the mirror device 105 (B), that of the wavelength of red is reflected on the mirror device 109 (R) and the light of which the one other than the lights of the wavelengths of blue and red has transmitted through (i.e., the light of the wavelength of green) is reflected on the mirror device 107 (G), all the lights of the respective colors are incident from the left when viewing from the respective directions of line of sight 202, 204 and 203. Therefore, in the upper row of FIG. 2B, the deflection direction of mirror for obtaining the ON light are equal for all individual mirrors 105a, 107a and 109a of the respective mirror devices 105, 107 and 109, and the left sides of the mirrors 105a, 107a and 109a deflect downward. Also in the lower row of FIG. 2B, the deflection directions of mirror for obtaining the ON light are equal for all individual mirrors 105a-1, 107a-1 and 109a-1 of the respective mirror devices 105, 107 and 109, and the left sides of the respective mirrors 105a-1, 107a-1 and 109a-1 deflect downward.

Tracing the light path of the ON light projecting the images 112B, 112G and 112R in the respective mirror devices 105, 107 and 109, the number of reflections of the ON light until reaching the projection lens 111 are two for the ON lights of the wavelengths of blue and red, and zero for the ON light of the green wavelength. As a result, a desired image 112 can be obtained without requiring a control for obtaining an image of a mirror image in all of the mirror devices 105, 107 and 109. Also in the case of obtaining an image 112 by changing the deflection axes and deflection direction of the mirrors 105a-1, 107a-1 and 109a-1 of the respective mirror devices 105, 107 and 109 as shown in the lower row of FIG. 2B, all the deflection axes and deflection directions of the mirrors 105a-1, 107a-1 and 109a-1 of the respective mirror devices can be made to be the same. Therefore, it is possible to perform the same image control for all images 112B-1, 112G-1 and 112-R, and a desired image 112 can be obtained without requiring a control for obtaining a mirror image for any of the mirror devices 105, 107 and 109. FIG. 2C is a table putting together the deflection axes of each mirror device, the state of image displayed at each mirror device and the deflection direction of the mirror shown in FIG. 2B. FIG. 2C shows the deflection axes of the mirrors 105a, 107a and 109a and those of the mirrors 105a-1, 107a-1 and 109a-1 of the respective mirror devices 105, 107 and 109 shown in the upper and lower rows of FIG. 2B; the states of the images 112B, 112G and 112R when viewing from the directions of line of sight 202, 203 and 204 and that of the images 112B-1, 112G-1 and 112R-1 when viewing from the directions of line of sight 202, 203 and 204; and the apexes of the mirrors 105a, 107a and 109a inclining downward and the sides of the mirrors 105a-1, 107a-1 and 109a-1 inclining downward. Note that the present specification document defines an upright image as “normal” and a mirror image as “reverse” for the state of an image.

The optical configuration shown in FIG. 2A does not necessitate a change of the deflection axis of a mirror, the deflection direction of the mirror or the state of an image, thereby making it possible to project a correct image free of a problem even by using the conventional mirror device. On the other hand, however, there is a problem of the optical configuration becoming complex and hence increasing cost of an apparatus. Currently, however, there is rarely an optical configuration, which is capable of lining up, to the same state, the deflection axes of mirrors, the state of images and the deflection directions of the mirrors. In fact, most of the multi-plate display apparatus comprises the optical configuration as shown in FIG. 2A, thus making it difficult to differentiate. The U.S. Pat. No. 0,114,214A1 has disclosed the method for reversing an image in a display apparatus. This reference document does not refer to a method for reversing an image related to the deflection axis of a mirror or the deflection direction thereof by using a mirror device for a multi-plate optical system. A change of the deflection axis of a mirror and that of the deflection direction thereof can simply be implemented by rotating a mirror device itself. In such a case, however, a signal wire electrically connecting the mirror device and external control circuit is also rotated with the mirror device, inviting a risk of a three-dimensional fault.

Therefore, a need still exists to further improve the image display systems such that the above discussed difficulties and limitations can be resolved.

### SUMMARY OF THE INVENTION

The present invention aims at a selection of the direction of the deflection axis of each mirror in a mirror device, a changeover of the deflection direction of a mirror in more directions than the conventional technique and an inversion of an image by using the mirror device.

Also aimed at is a provision of a display apparatus, which comprises at least one of the mirror devices of the present invention.

A first aspect of the present invention is to provide a display apparatus comprising: a plurality of mirror devices including plural deflectable mirrors which modulate an incident light emitted from a light source and reflect the incident light to an ON direction leading a reflection light of the incident light to a projection light path or reflect it to an OFF direction not leading the reflection light to the projection path; control means for controlling the deflection of the mirror; and a projection optical system for projecting the light reflected by the mirror to the ON direction, wherein the direction of the deflection axis of the mirror of at least one mirror device among the plurality thereof is different from that of the deflection axis of the mirror of the other mirror devices.

A second aspect of the present invention is to provide a display apparatus comprising: a plurality of mirror devices including plural deflectable mirrors which modulate an incident light emitted from a light source and reflect the incident light to an ON direction leading a reflection light of the incident light to a projection light path or reflect it to an OFF direction not leading the reflection light to the projection path; control means for controlling the deflection of the mirror; and a projection optical system for projecting the light reflected to the ON direction, wherein the deflection direction of the mirror reflecting the incident light to the ON direction of at least one mirror device among the plurality thereof is different from the deflection direction of the other mirror devices.

A third aspect of the present invention is to provide a mirror device, comprising plural deflectable mirrors which modulate an incident light emitted from a light source and reflect the incident light to an ON direction leading a reflection light of the incident light to a projection light path or reflect it to an OFF direction not leading the reflection light to the projection path, and control means capable of changing over the direction of the deflection axis of the mirror and/or the deflection direction of the mirror in a discretionary direction.

A fourth aspect of the present invention is to provide a display apparatus comprising: a light source; a plurality of mirror devices including at least one of the mirror devices according to the third aspect of the present invention, control means for controlling the mirror devices; and a projection optical system for projecting the light reflected to the ON direction.

A fifth aspect of the present invention is to provide a mirror device, comprising, on the same substrate, a plurality of mirror arrays including plural deflectable mirrors which reflect an incident light emitted from a light source to an ON direction leading a reflection light of the incident light to a projection light path or reflect it to an OFF direction not leading the reflection light to the projection path, wherein the direction of the deflection axis of the mirror of at least one mirror array among the plurality thereof is different from that of the deflection axis of the other mirror arrays.

A sixth aspect of the present invention is to provide a mirror device, comprising, on the same substrate, a plurality of mirror arrays including plural deflectable mirrors which reflect an incident light emitted from a light source to an ON direction leading a reflection light of the incident light to a projection light path or reflect it to an OFF direction not leading the reflection light to the projection path, comprising control means for transmitting an image signal corresponding to each of the mirror arrays, wherein the deflection direction of the mirror reflecting the incident light to the ON direction of at least one mirror array among the plurality thereof is different from the deflection direction of the other mirror arrays.

The use of the mirror device according to the present invention makes it possible to broaden a scope of selecting an optical configuration of a display apparatus and also simplifies the optical configuration of the display apparatus.

These and other objects and advantages of the present invention will no doubt become obvious to those of ordinary skills in the art after reading the following detailed description of the preferred embodiment, which is illustrated in the various drawing figures.

### BRIEF DESCRIPTION OF THE DRAWINGS

FIG. 1A shows a configuration of a conventional image display system comprising a spatial light modulator (SLM);

FIG. 1B shows a configuration, and a control, of a spatial light modulator as shown FIG. 1A;

FIG. 1C exemplifies a control circuit for a mirror element;

FIG. 1D shows the “binary time periods” in the case of controlling an SLM by four bit words;

FIG. 2A shows an overall optical configuration of a conventional multi-plate display apparatus;

FIG. 2B shows the deflection axes of mirrors of each mirror device, the state of an image displayed in each mirror device and the deflection directions of the mirrors;

FIG. 2C is a table putting together the deflection axes of mirrors of each mirror device, the state of an image displayed in each mirror device and the deflection directions of the mirrors which are shown in FIG. 2B;

FIG. 3A exemplifies a configuration of a mirror device allowing a changeover of the deflection axis of a mirror and of the deflection direction thereof;

FIG. 3B exemplifies the deflection axes of respective mirrors, the deflection directions of the respective mirrors and the state of an image in each mirror device shown in FIG. 3A;

FIG. 4A exemplifies a common process for a control signal at an external control circuit 400 connected to a mirror device;

FIG. 4B exemplifies a process for inverting a control signal at an external control circuit 400 connected to a mirror device;

FIG. 5A exemplifies a common process for a control signal within a mirror device;

FIG. 5B exemplifies a process for inverting a control signal within a mirror device;

FIG. 6A exemplifies an optical configuration of a multi-plate display apparatus comprising a mirror device according to the present embodiment;

FIG. 6B exemplifies the deflection axis of a mirror, the state of an image, and the deflection direction of a mirror inclining downward, in each mirror device shown in FIG. 6A;

FIG. 6C exemplifies the deflection axis of a mirror, the state of an image, and the deflection direction of a mirror inclining downward, of each mirror device shown in FIG. 6B;

FIG. 7A is a modified embodiment of the multi-plate display apparatus shown in FIG. 6A when the deflection axis of a mirror of a mirror device is not placed on the diagonal line of the mirror;

FIG. 7B exemplifies the deflection axis of a mirror, the state of an image and the deflection direction of a mirror inclining downward in each mirror device when the deflection axis of the mirror of each mirror device shown in FIG. 6A is placed on the center division line of the mirror;

FIG. 8 exemplifies the method for inverting an image projected on a mirror device in a conventional mirror device;

FIG. 9A is an outline diagram of a display apparatus comprising a mirror device and a projection lens both according to the present embodiment in the case of the light source existing on the left side; and

FIG. 9B is an outline diagram of a display apparatus comprising a mirror device and a projection lens both according to the present embodiment in the case of the light source existing on the right side.

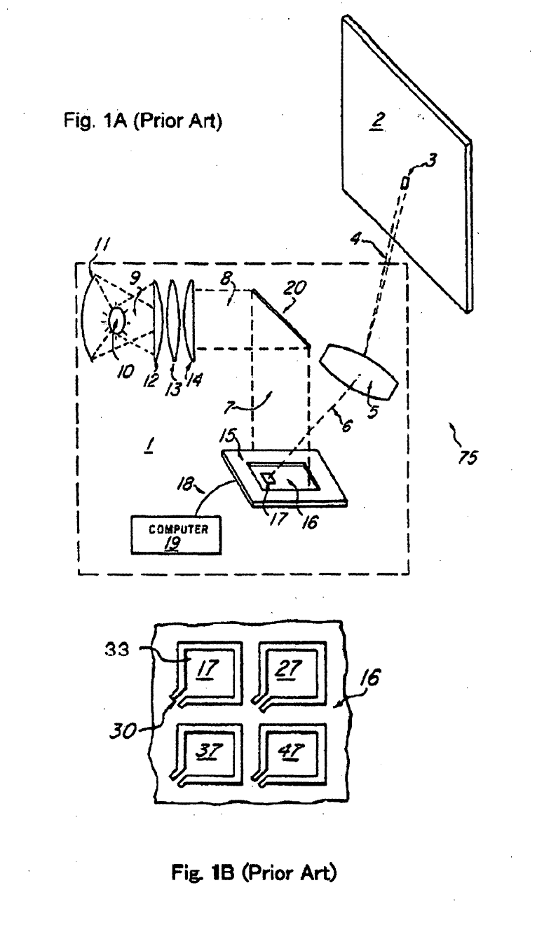

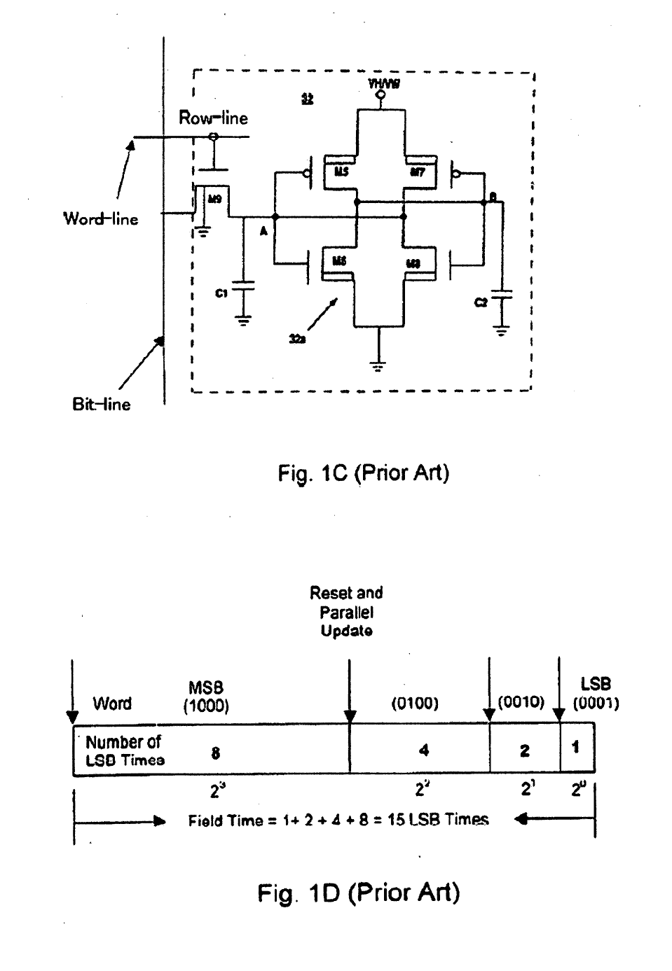

### DESCRIPTION OF THE PREFERRED EMBODIMENTS

Reference is now made to the above listed Figures for the purpose of describing, in detail, the preferred embodiments of the present invention. The Figures referred to and the accompanying descriptions are provided only as examples of the invention and are not intended in anyway to limit the scope of the claims appended to the detailed description of the embodiment.

The descriptions below are directed to a mirror device, which changes the deflection axis of a mirror to allow for more deflection directions than a mirror formed and controlled with a conventional technique.

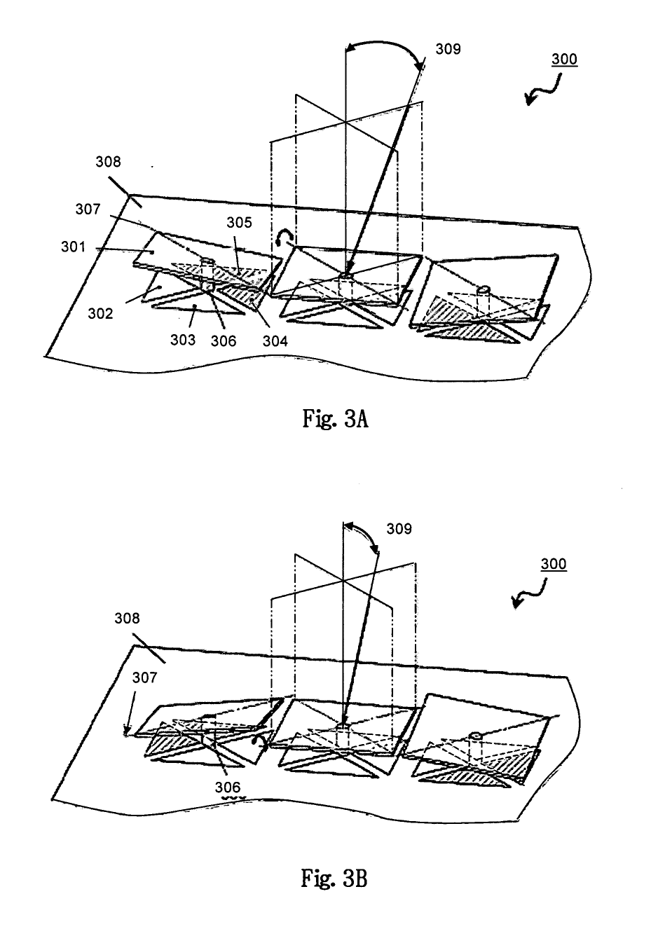

Referring to FIGS. 3A and 3B for a description of a mirror device with a new and improved configuration to allow a changeover of the deflection axis of a mirror and also the mirror deflection direction. The descriptions included in the specification describe the configuration and principle of a single mirror element that are also applicable to all other mirror elements.

The mirror device 300 shown in FIGS. 3A and 3B comprises a substrate 308 and a plurality of mirror elements. The substrate 308 is composed of an insulation material, e.g., silicon. One mirror element includes a mirror 301 supported on an elastic hinge 306 placed on the substrate 308. The mirror also includes a plurality of electrodes 302, 303, 304 and 305 disposed under the mirror 301. As an example, four electrodes 302, 303, 304 and 305 are disposed in the front, back, left and right sides, i.e., four ways, under the mirror 301. These electrodes 302, 303, 304 and 305 are provided in a manner not to physically touch with each other. In a state when there are no voltages applied to any of the electrodes, the mirror 301 is held at a horizontal position relative to the substrate 308. An insulation layer, e.g., a layer of alumina or SiC, is deposited on the electrodes 302, 303, 304 and 305. Each of the individual electrodes 302, 303, 304 and 305, is electrically connected to a drive circuit (not shown in the drawing herein), is capable of changing the potentials by receiving a control signal.

The mirror 301 is composed of a reflective material such as aluminum. The mirror 301, being supported by an elastic hinge 306, is commonly configured to maintain an initial position of the mirror surface, i.e., a horizontal position according to FIGS. 3A and 3B. The initial state sets the voltage applied to each of the electrodes 302, 303, 304 and 305 to zero, making the potential of the mirror 301 equal to that of the respective electrodes 302, 303, 304 and 305. The mirror 301 may be configured to have different sizes and shapes depending on the requirements of special applications.

The entirety or a part of the elastic hinge 302 such as the base part, neck part or middle part, is composed of silicon or a metallic material that is an elastic body possessing resilience. The flexural rigidity of the elastic hinge 306 is preferred to be the same for all selectable directions of the deflection axes for the present embodiment, and moreover the flexural rigidity in a direction different from the deflection direction of the mirror is preferably to be higher than that in the deflection direction of the mirror. The shape and size of the elastic hinge 306 may be flexibly designed and manufactured according to specific application requirements. As an example, a configuration may be such that the elastic hinge of a mirror is formed to have a solid rectangular shape and that the diagonal line of the solid rectangular hinge is oriented to a direction other than the front, back, left and right (i.e., four ways) of the deflection direction of the mirror. And in an exemplary embodiment, the cross-sectional area of the elastic hinge 306 may be different between the base part and tip part of the hinge 306.

Referring again to FIGS. 3A and 3B for a description of the operational principle of changing the deflection axis 307 of the mirror 301 of the mirror device 300 over to a different direction. The center mirror element shown in FIGS. 3A and 3B illustrates the initial state of one mirror 301 of them configured as described above. A voltage of zero volt is applied to the electrodes 302, 303, 304 and 305 disposed respectively in the front, back, left and right sides around the mirror hinge 306 on the substrate 308 under the mirror 301. The mirror surface is controlled to maintain at a position along a direction parallel to the plane of the substrate 308. The mirror element on the left side of FIG. 3 illustrates an example that the mirror is inclined to the far right side relative to the horizontal plane. The mirror 301 is drawn to incline to the far right side relative to the horizontal plane when voltages are applied to electrodes 304 and 305 to generate a coulomb force. As the potential of the electrodes 304 and 305 on the substrate 308 shown as electrodes covered by shaded areas, an electrical potential is generated between the mirror 301 and the electrodes 304 and 305. The Coulomb force is generated between the mirror 301 and the electrodes 304 and 305.

The mirror element on the right side of FIG. 3A illustrate an example of the mirror element is controlled to incline to the left relative to the horizontal plane. This is achieved by changing of the potentials of the electrodes 302 and 303 shown as electrodes covered by the shaded areas. The electrical voltages applied to these electrodes cause a coulomb force to draw the mirror surface to incline to the left as illustrated in FIG. 3A. Similarly, FIG. 3B illustrates the mirror surface of the mirror disposed on the left side of the substrate inclines to the left and the mirror element disposed on the right side on the substrate inclines to the right when the voltages are applied to respective electrodes, i.e., electrodes 302, 305 and 303, 305 respectively, shown as electrodes covered with shaded areas. The controls as described above allow the change of the deflection axis 307 of the mirror, enabling the inclination direction of the mirror in more directions than the conventional technique. More convenience is provided to handle and control each mirror to deflect by changing the deflection axis of the mirror and the deflection direction. The flexibility is achieved because of mirrors are supported on elastic hinges and multiple electrodes are strategically disposed on all sides of each hinge. Also, the maximum deflection angle of the mirror can be determined by forming a stopper (not shown in a drawing herein) under the mirror and adjusting the height and distance of the stopper from the hinge placed in the vicinity of each electrode. For example, in FIGS. 3A and 3B the stoppers are placed between the electrodes 302 and 303, between the electrodes 303 and 304, between the electrodes 304 and 305, and between the electrodes 305 and 302, respectively, makes it possible to determine the ranges of deflection angles of the mirror to different directions. The height of the stopper may not have to be the same in the right near side, left near side, right far side, and left far side, of the plane. The deflection angles of the mirror may be configured to be different among the right near side, left near side, right far side, and left far side, of the plane. Furthermore, the shape and size of each stopper may be properly modified, and an electrode covered with an insulation layer may also serve the function as a stopper. Different combinations of voltages may also be applied to individual electrodes or simultaneously to multiple electrodes to flexibly change the deflection axis, the deflection direction and deflection angle of the mirror.

Furthermore, the number of electrodes may be increased or decreased by either implementing each of the electrodes shown in FIGS. 3A and 3B as two or more electrodes, or inversely by combining two or more electrodes as one electrode. The shapes and sizes of the electrodes may also be flexibly changed. A controller may also be flexibly designed to control the deflection of single mirror of multiple mirrors as a control block by applying different control signals.

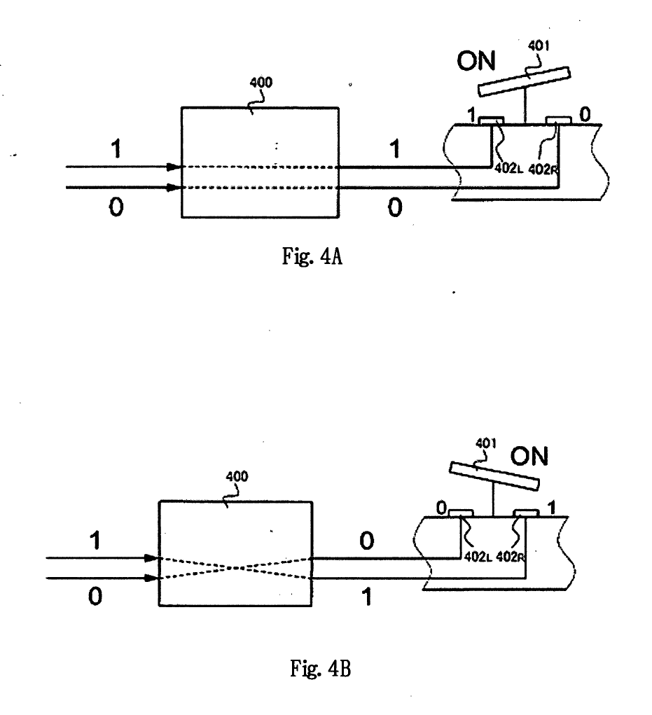

A control signal process of a mirror device for inverting the deflection direction of the mirror and that of a mirror device for inverting an image signal from left to right referred to as “horizontal inversion” is described below. In FIGS. 4A and 4B, the state of applying a voltage to the electrodes 402L or 402R of the mirror element 401 for obtaining the ON light is defined as “1”, while the state of not applying a voltage is defined as “0”. Specifically, FIG. 4A exemplifies a common process for applying a control signal from an external control circuit 400 connected to a mirror device. The external control circuit 400 transmits a control signal denoted as “1” and “0” to the electrodes 402L and 402R of the mirror element 401 to control the deflection direction of the mirror device. A state of projecting an ON light is obtained by the mirror inclining to the left when a signal “1” is transmitted to the left electrode 402L of the mirror element 401.

In contrast, FIG. 4B exemplifies a process executed by the external control circuit 400 for inverting a control signal transmitted to the mirror device. The external control circuit 400 comprises an inversion circuit for inverting the “1” and “0” of a control signal. The inversion circuit performs the process for inverting the control signal. The inverted control signal causes an inversion of the deflection direction of the mirror thus carrying out a horizontal inversion when an image signal is projected with the inverted control signal applied to the electrodes 402L and 402R of the mirror element 401. Specifically, the mirror is generally inclined to the left with a control signal of “1” transmitted to the left end electrode 402L of the mirror element 401. When the “1” of the control signal is inverted by the inversion circuit within the external control circuit 400. The “1” of the control signal is transmitted to the right end electrode 402R of the mirror element 401. The mirror is controlled to incline to the right, thereby obtaining the ON light. The external control circuit 400 comprises an electric circuit that includes transistors as switching circuits and other necessary circuit components to function as a signal inverting circuit to perform the process of inverting a control signal.

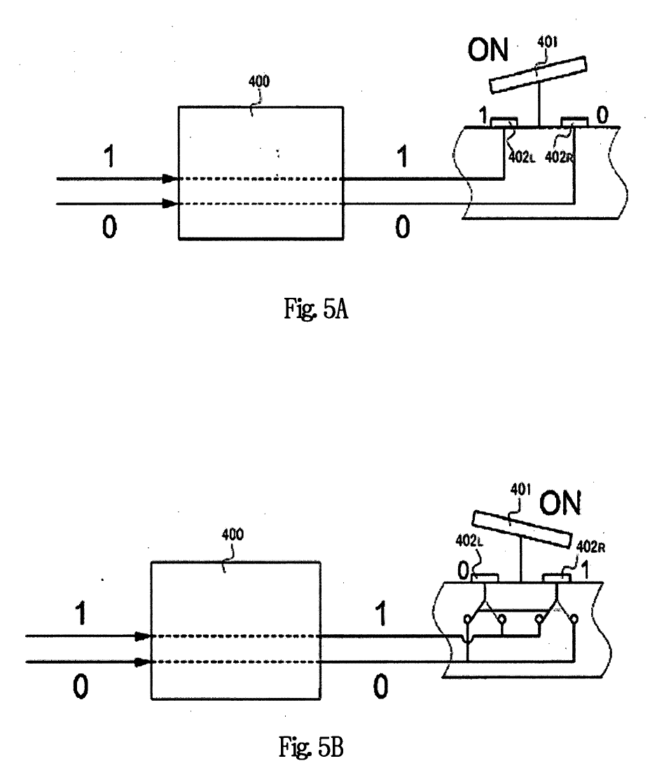

FIGS. 5A and 5B illustrates an exemplary process for applying a control signal of a mirror device, and a process for inverting the control signal. In FIGS. 55A and 5B, when a voltage is applied to the electrodes 402L or 402R of the mirror element 401 for obtaining the ON light, the control signal is defined as “1”. Conversely, the control signal is defined as “0” for the state of not applying a voltage. Specifically, FIG. 5A illustrates the process for applying a control signal when a mirror device is not operated in an inverted state. The external control circuit 400 transmits a control signal of “1” and “0” to electrodes 402L and 40R respectively to the mirror device, thereby controls the deflection direction of the mirror device. In this case, the deflection angle to reflect and project an ON light is obtained by the mirror inclining to the left by applying the signal “1” to the left end electrode 402 of the mirror element 401.

Conversely, FIG. 5B illustrates the process for inverting a control signal within a mirror device. The external control circuit 400 comprises an inversion circuit for inverting the “1” and “0” of a control signal. The inversion circuit performs the process for inverting the control signal. The inverted control signal causes an inversion of the deflection direction of the mirror thus carrying out a horizontal inversion when an image signal is projected with the inverted control signal applied to the electrodes 402L and 402R of the mirror element 401. Specifically, the mirror is generally inclined to the left with a control signal of “1” transmitted to the left end electrode 402L of the mirror element 401. When the “1” of the control signal is inverted by the inversion circuit within the external control circuit 400. The “1” of the control signal is transmitted to the right end electrode 402R of the mirror element 401. The mirror is controlled to incline to the right, thereby obtaining the ON light. The external control circuit 400 comprises an electric circuit that includes transistors as switching circuits and other necessary circuit components to function as a signal inverting circuit to perform the process of inverting a control signal.

The mirror device applied with the process described above is further described below. An exemplary mirror device includes a plurality of mirrors arranged as mirror arrays on a substrate. The configuration is particularly illustrated in a manner to differentiate the direction of the deflection axis of at least one mirror array from that of other mirror arrays among the plurality of mirror arrays. An image signal applicable to each mirror array is transmitted from an external control circuit to each mirror array based on the address of the transmission destination of the image signal. The address of the transmission destination of the image signal is designated for a specific mirror array. The control signal transmitted to the specific mirror array to perform the controls such as an inversion of the image signal in the horizontal direction (that is, a mirror image) and that of the image signal in the vertical direction.

In an exemplary embodiment, it is possible to differentiate the address of transmission destination of an image signal by forming a physical wiring separately connected to different mirror arrays. It is also possible to differentiate the address of the transmission destination by rearranging a transmission sequence for transmitting an image signal. The transmission sequence is a sequence arbitrarily determined for appropriately inverting an image in a horizontal or vertical direction. As an example, an image signal drawing a common upright image is first transmitted to a mirror array excluding a specific mirror array. Then, the signal transmission proceeds by transmitting, to a specific mirror array, an image signal drawing a mirror image that inverts an image in the horizontal direction. Such a rearrangement of the transmission sequence for transmitting an image signal makes it possible to differentiate the transmission address by way of the transmitting the signals through the same signal transmission routes. In an exemplary embodiment, an external control circuit is programmed to carry out such a rearrangement of the transmission sequence.

The transmission address is not only applied for transmitting an image signal but also for transmitting a control signal for controlling the deflection direction of a mmror. The transmission address therefore designates a specific mirror array as described above. The control signal is applicable not only to the mirror device but also to the mirror device according to the present embodiment, as shown in FIGS. 3A and 3B. A plurality of approximate square-shaped mirrors are arrayed as mutually parallel square-shaped mirrors in the same direction. The deflection axes of the mirror are placed on the two diagonal lines the mirror. Furthermore, the image control described above is applicable to the mirror device according to the present embodiment. The display system comprises a plurality of mirror arrays and to allow a selection of the deflection axis of the mirror and of the deflection direction thereof.

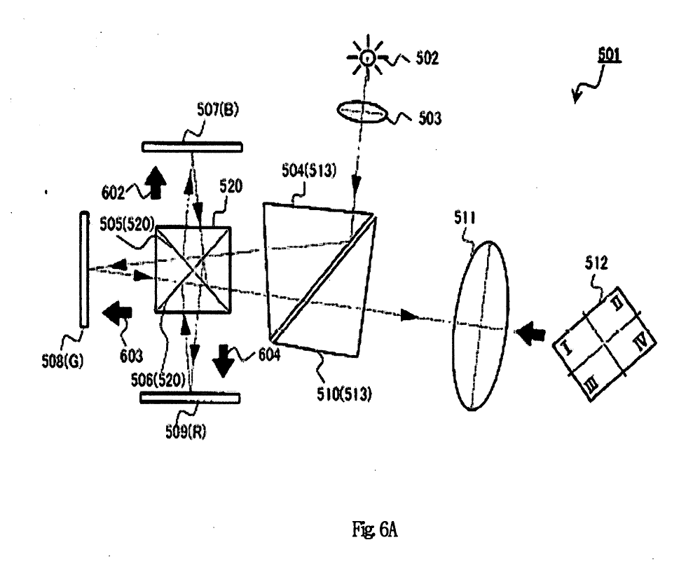

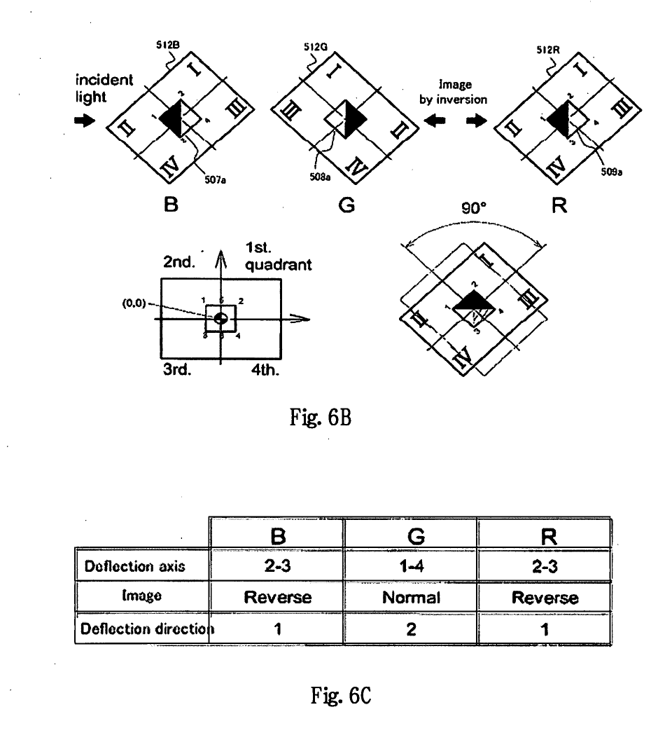

Referring to FIG. 6 the optical configuration and projection principle of a display apparatus that includes the mirror device described above. FIG. 6A shows an exemplary embodiment of a display apparatus comprising a mirror device described above. FIG. 6A shows a display apparatus that includes a light source 502, a condenser optical system 503, a total internal reflection prism 513, a color separation/synthesis prism 520, three mirror devices 507, 508 and 509, and a projection optical system 511. The light source 502 emits light for projecting an image. The light source 502 may be an arc lamp light source, a laser light source or a light emitting diode (LED). The light source 502 may includes a plurality of sub-light sources. The light intensity can be adjusted by controlling each of these sub-light sources. A further control of local intensity is achievable by biasing the position of each of the sub-light sources.

When a laser light source or LED light source is implemented as light source 502, the laser light source or LED light source may be controlled to pulse-emit the source light according to specific display system requirements. The laser light source projects a near-parallel flux of light and a small light dispersion angle. Based on the relation of etendue, the numerical aperture NA of an illumination light flux of the flux reflecting on the mirror device that is a spatial light modulator can be reduced. An interference of the illumination light flux before and after reflection from the mirror device is reduced. And the optical fluxes can be arranged to project along optical paths closer to each other. As a result, the size of the mirror can be reduced and also smaller deflection angle of the mirror can be arranged without causing display quality degradation due to optical interferences. Furthermore, compared to the display apparatuses implementing with conventional technologies, it possible to shorten the difference of the lengths of the light paths between the incident light and reflection light. There are greater amount of light of incident light and reflection light with higher light intensities enter the mirror array and projection path. Therefore, the deflection angle of the mirror can be reduced by using a laser light source and furthermore, the display systems also able to project a brighter image.

As shown in FIG. 6A, the condenser optical system 503 comprises an optical element for condensing light and one for generating light with uniform intensity. The condenser optical system 503 carries out the role of adjusting the intensity of light, the quantity of light, the emission range of light and such. As examples, an optical element for condensing light may include a collector lens and the one for generating uniform light intensity includes a rod integrator and a fly eye lens. A total internal reflection prism 513 includes two triangle prisms, i.e., a first prism 504 and a second prism 510. The first prism 504 is applied to totally reflect the incident light. As an example, the first prism 504 totally reflects the incident light to the light path entering the reflective spatial light modulator. The totally reflected light is modulated by the reflective spatial light modulator and reflected to the second prism 510. The second prism 510 transmits the reflection light incident thereto along a direction less than a critical angle. The reflected light is projected to the reflective spatial modulator and is further modulated by the reflective spatial light modulator. According to such light transmission sequences, the second prism 510 carries out the function of transmitting the incident light entering thereto along a direction that is less than the critical angle and the function of reflecting the incident light along a direction that is at the critical angle or more.

The color separation/synthesis prism 520 includes a color selection filter 505 for reflecting only the light of the wavelength of blue (noted as “blue wavelength” for simplicity hereinafter) and transmitting the light of other colors. The color separation/synthesis prism 520 further includes a color selection filter 506 for reflecting only the light of the wavelength of red (noted as “red wavelength” hereinafter). Placing the two filters in the prism 520 in an approximate “X” configuration processes transmission of the light of other colors. The transmission of light through such color selection filters 505 and 506 enables a spectroscopic separation (simply noted as “separation” hereinafter) of light. On the other hand, in different embodiments, by applying such color selection filters 505 and 506 also enables synthesis of once-separated lights. Furthermore, the characteristics of color filters for reflecting and transmitting lights may be flexibly arranged and changed. As an example, a display system may implement a color selection filter reflecting only the light of the wavelength of green (noted as “green wavelength” hereinafter). Alternately, a display system may implement color filters for transmitting other colors in place of the color selection filter 505 for reflecting only the light of the blue wavelength. The present invention thus discloses image display systems that includes color separation/synthesis member, a member separating a light and synthesizing a light (i.e., the color separation/synthesis prism 520) based on the wavelength of light as described above. It also discloses image display systems that include a member reflecting the light of the wavelength of a specific color and transmitting the other colors (i.e., the color selection filters 505 and 506) as “color separation element”. In an embodiment, the mirror devices 507, 508 and 509 are configured as described above. The individual mirror devices 507, 508 and 509 carry out the role of modulating an incident light based on the image signal received from a control circuit (not shown in a drawing herein), and reflecting the modulated light. The control circuit (not shown) controlling the spatial light modulator 26 and sends an image signal to the individual mirror devices 507, 508 and 509, and controlling the respective mirror elements to carry out image modulation for the mirror devices. The projection optical system 511 carries out the function of enlarging the light reflected and modulated by the mirror device so as to project a display image onto the screen with designated ratio of image enlargement.

The following descriptions explain the principle of projection in the display apparatus shown in FIG. 6A. The light emitted from the light source 502 passes through the condenser optical system 503 and enters the first prism 504, along a direction of an angle at the critical angle or more, relative to the total internal reflection prism. Then, the light is totally reflected by the first prism 504 of the total internal reflection prism and enters the color separation/synthesis prism 520. Then, the light transmits to the color selection filter 505. The color selection filter 505 reflects only the light of the blue wavelength and transmits the light of other colors. A color selection filter 506 reflects only the light of the red wavelength and transmits the light of other colors. The illumination light is separated into lights of the blue wavelength, red wavelength and green wavelength. The separated lights then enter the respective mirror devices 507, 508 and 509 disposed opposite to the ejection surface of the separated lights of the color separation/synthesis prism 520. The individual mirror devices 507, 508 and 509 modulate the incident lights of the respective colors based on the image signals corresponding to the lights of the respective colors received from the control circuit (not shown in a drawing herein). The mirror devices then reflect the modulated lights of the respective colors to the color separation/synthesis prism 520.

The lights of individual colors modulated, reflected back from the respective mirror devices 507, 508 and 509 are synthesized by the color selection filter 505. The color selection filter 505 reflects only the light of the blue wavelength and transmitting the light of other colors. The color selection filter 506 reflects only the light of the red wavelength and transmitting the light of other colors, which are placed a lá character “X” within the color separation/synthesis prism 520. Then, the synthesized light synthesized from the modulated lights of the respective colors enters the second prism 510 of the total internal reflection prism along a direction of less than the critical angle and transmits through the projection optical system 511. An image 512 is then projected onto the screen.

FIG. 6A shows the image 512 viewing from the direction of line of sight (also noted as “sight line” hereinafter) 601 as I, II, III and IV. Note that FIGS. 6A and 6B show the first, second, third and fourth quadrants of the image 512 each designated as I, II, III and IV, respectively. FIG. 6B shows the individual images 512B, 512G and 512R when viewing the individual mirror devices 507, 508 and 509 from the respective directions along the lines of sight as designated by 602, 603 and 604.

FIG. 6B illustrates the angular positions of the individual mirrors for generating the ON lights of image display of the respective mirror devices 507, 508 and 509 that have approximate square shape shown as 507a, 508a and 509a, respectively. The apexes of each mirror at four corners are designated as 1, 2, 3 and 4. FIG. 6B shows a part of the mirror that is inclining downward by showing this part with a black solid area and a part thereof inclining upward by showing this part as a white solid area. Furthermore, a coordinate system of each mirror and image as illustrated in FIG. 6B are specifically defined. As shown in the lower row of FIG. 6B, the center of the image 512 is defined as coordinates (0, 0), the individual apexes of each mirror as 1, 2, 3 and 4, the center of the apexes 1 and 2 as “5”, and the center of the apexes 3 and 4 as “6”. And the mirror device 507 for processing the light of the blue wavelength is defined as “B”. The mirror device 509 for the light of the red wavelength is defined as “R”. The mirror device 508 for processing the transmission light (that is, the light of the green wavelength) other than the light of the blue wavelength and the light of the red wavelength is defined as “G”.

FIG. 6B shows the images 512B, 512G and 512R in the respective mirror devices 507, 508 and 509 viewing from the respective directions of sight lines 602, 603 and 604. These images are overlapped with the approximate squares approximate squares 507a, 508a and 509a representing the mirrors in the respective mirror devices 507, 508 and 509. The image 512 is a view observed from the direction along a line of sight 601 in FIG. 6A. According to a configuration of the individual mirrors 507a, 508a and 509a of the respective mirror devices 507, 508 and 509, the light of the blue wavelength enters from the left side of the mirror device 507 (B) and also the light of the red wavelength enters from the left side of the mirror device 509 (R) when viewing from the respective direction of sight lines 602 and 604. On the other hand, when viewing from the direction of sight line 603, the transmission light, that is, the light of the green wavelength, other than the light of the blue wavelength and the light of the red wavelength, enters from the right side of the mirror device 508 (G). Therefore, in order to obtain the image 512 by reflecting the incident light onto the projection optical system 511 as an ON light, the deflection direction of the mirror 507a corresponding to the light of the blue wavelength and that of the mirror 509a corresponding to the light of the red wavelength must be different from the deflection direction of the mirror 508a corresponding to the light of the green wavelength. Therefore, the image I, II, III and IV of the mirror device 507 (B) and mirror device 509 (R) must be inverted in the horizontal direction from the image I, II, III and IV of the mirror device 508 (G) when viewing from the respective directions of sight lines 602, 603 and 604, in order to obtain the image 512. According to the projection sequence and direction of the lights with different wavelengths of respective colors from the image 512, the images 512B and 512R to be displayed in the mirror devices 507 (B) and 509 (R), respectively, must be projected in mirror images, while the image 512G to be displayed in the mirror device 508 (G) is an upright image as shown by the B, G and R in FIG. 6B. FIG. 6C is a table lists the deflection axis of the mirror of each mirror device shown in FIG. 6B, the state of an image displayed in each mirror device, and the deflection direction of the mirror. Specifically, FIG. 6C shows the deflection axes of the mirrors 507a, 508a and 509a; the state of I, II, III and IV of the images 512B, 512G and 512R; and the sides (i.e., the deflection directions) of the individual mirrors 507a, 508a and 509a that incline downward; of the mirror devices 507, 508 and 509 respectively.

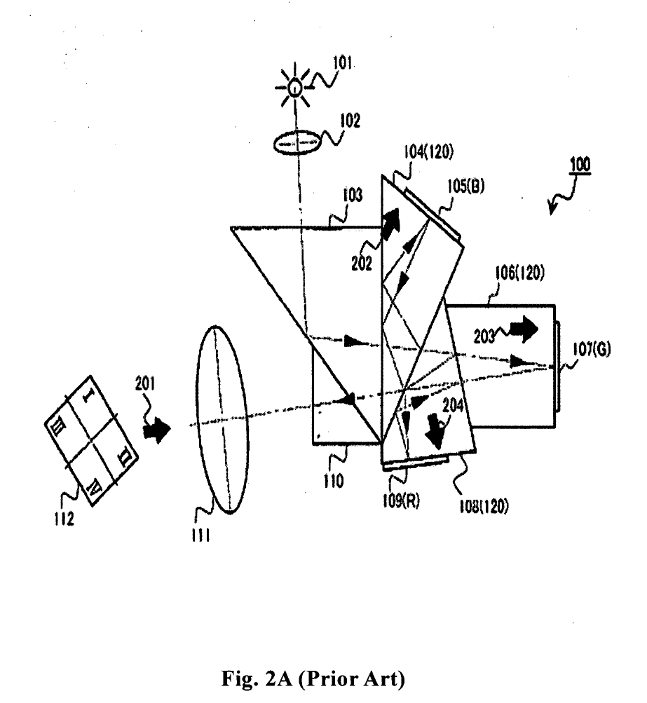

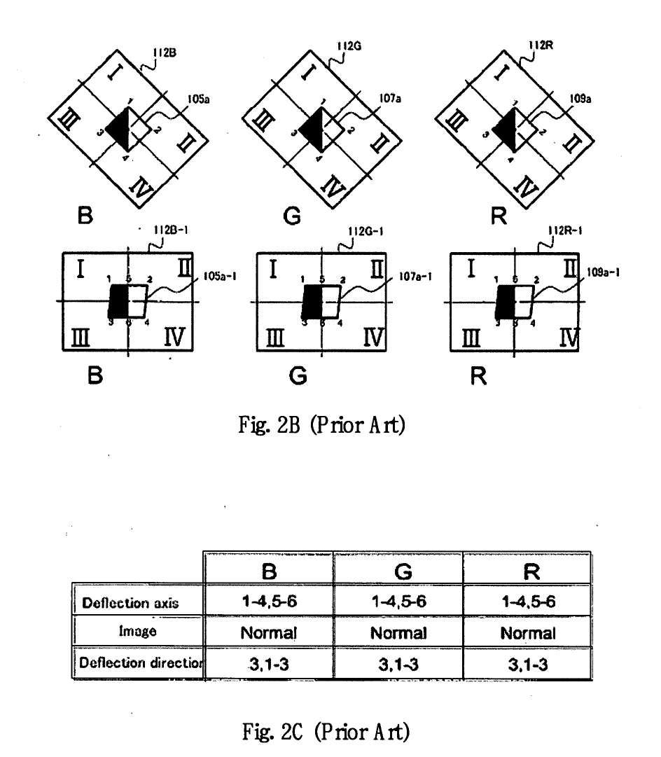

The optical configuration shown in FIG. 6A has the advantages of a simpler configuration and more compact than the conventional optical configuration shown in FIG. 2A. It is necessary to differentiate the deflection axis and deflection direction of the mirror devices 508 (B) and 509 (R) from those of the mirror device 508 (G) as shown in FIG. 6C. According to the conventional technique, the mirror devices possessing the mutually different deflection axes and deflection directions are required to be designed individually. The display apparatus according to the present embodiment, however, comprises the mirror device setting the deflection axis of a mirror device different from other mirror devices. It is possible to provide a simpler optical system and more compact than the conventional display systems. Further the mirror device as disclosed in the present invention allows for a free control of the deflection axis of a mirror, the deflection direction of the mirror and the deflection angle thereof as described above eliminates a necessity of designing individual mirror devices.

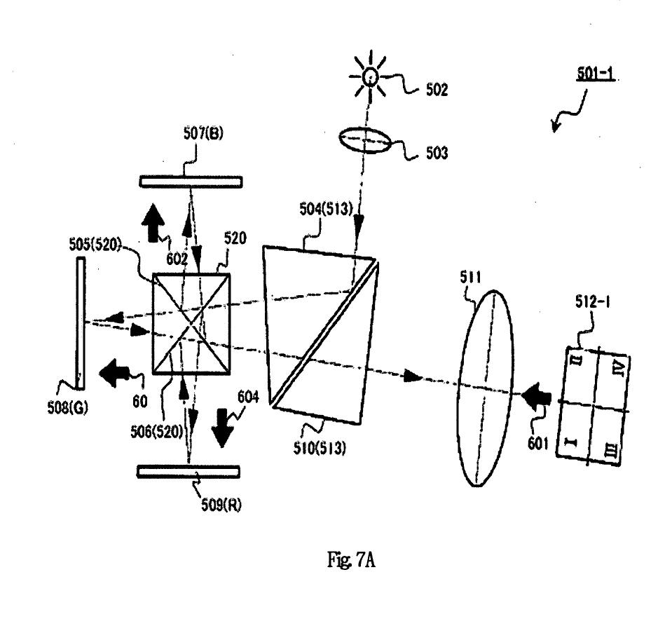

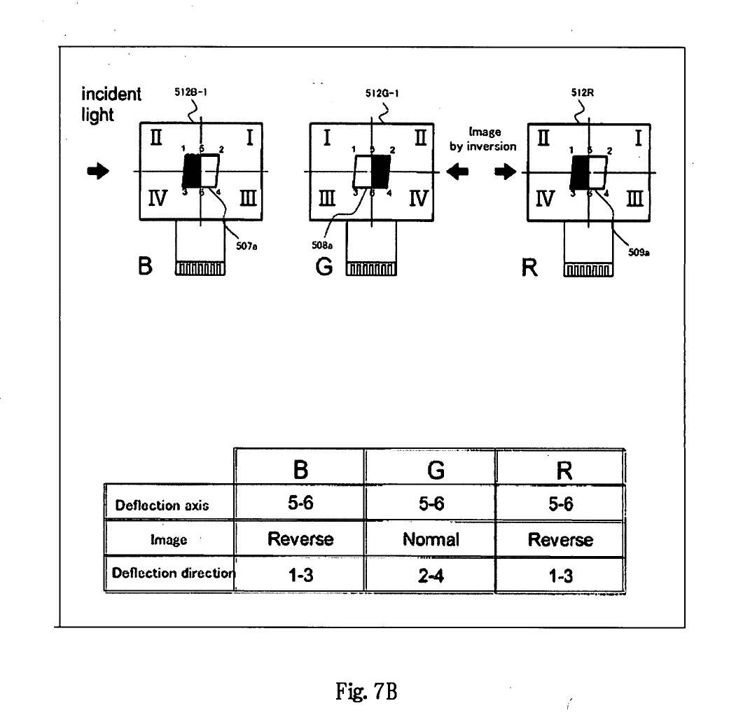

FIG. 7A is schematic diagram for showing a modified embodiment of the multi-plate display apparatus 501-1 of FIG. 6A when the deflection axis of a mirror of a mirror device is not placed on the diagonal line of the mirror. The optical system of the display apparatus shown in FIG. 7A is configured similarly to the one shown in FIG. 6A according to above descriptions. The mirror device used for the display apparatus of FIG. 7A is an alternate exemplary embodiment of the mirror device of FIG. 6A. Unlike the one shown in FIG. 6A, the mirror device shown in FIG. 7A is configured with the deflection axis of the mirror disposed above described mirror device on the center division line of the mirror instead of the diagonal line thereof. FIG. 7A illustrates an image 512-1 when viewing from the direction of sight line 601 as in the case of FIG. 6A. FIG. 7B shows the images 512B-1, 512G-1 and 512R-1 displayed in the respective mirror devices for projecting the image 512-1 shown in FIG. 7A when overlapped with the images projected from respective mirror devices 507a, 508a and 509a. The deflection direction of the mirrors is changed similar to that described above as shown in FIG. 7B, thereby enabling a projection of the image 512-1. A display of the image projected in mirror image by the mirror devices 507 (B) and 509 (R), respectively, and a display of a normal image by the mirror device 508 (G) enable a combination and projection of the display image 512-1.

FIG. 7B also shows the deflection axes of the mirrors 507a, 508a and 509a, the states of the images and the deflection directions of the mirrors 507a, 508a and 509a which incline downward in each mirror device respectively when displaying the image 512-1. As described above, a proper control for selecting the directions of the deflection axes of mirrors in the mirror device, changing over the deflection directions of the mirrors, inverting applicable images (e.g., mirror images) are disclosed to project a desired image.

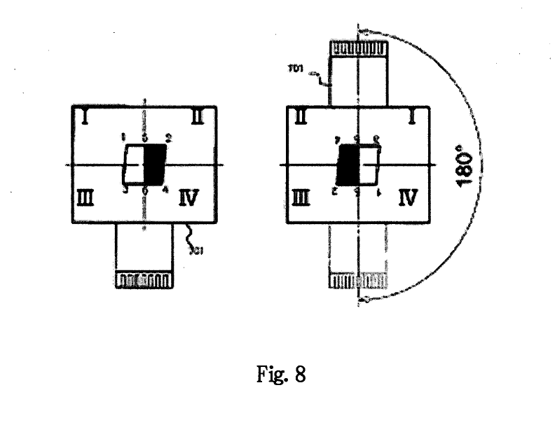

FIG. 8 shows an alternate embodiment that does not require a display system to place the deflection axis of a mirror on the diagonal line thereof as shown in FIGS. 7A and 7B. The mirror device is configured by rotating the system with a 180 degrees for projecting a display of the image that is inverted in up/down/left/right according to the rotation shown in FIG. 8. Accordingly, it is not required to change the deflection axis of a mirror. This embodiment provides an advantage that the signal wires connected to an external circuit for controlling the mirror device are not required to be inverted. Potential problems of failures such as a three-dimensional fault of the signal wire, a preclusion of a common connection with a substrate, et cetera, can be prevented. The mirror device according to the present embodiment also makes it possible to invert an image while a signal wire 701 connecting to an external circuit is properly maintained, and therefore provide a freedom of laying out the optical system of a display apparatus. Note that the left side of FIG. 8 shows a common upright image at a mirror device.

The advantage of the display apparatus using a mirror device that allows a selection of the deflection axis of a mirror and the deflection direction as described above is further discussed below.

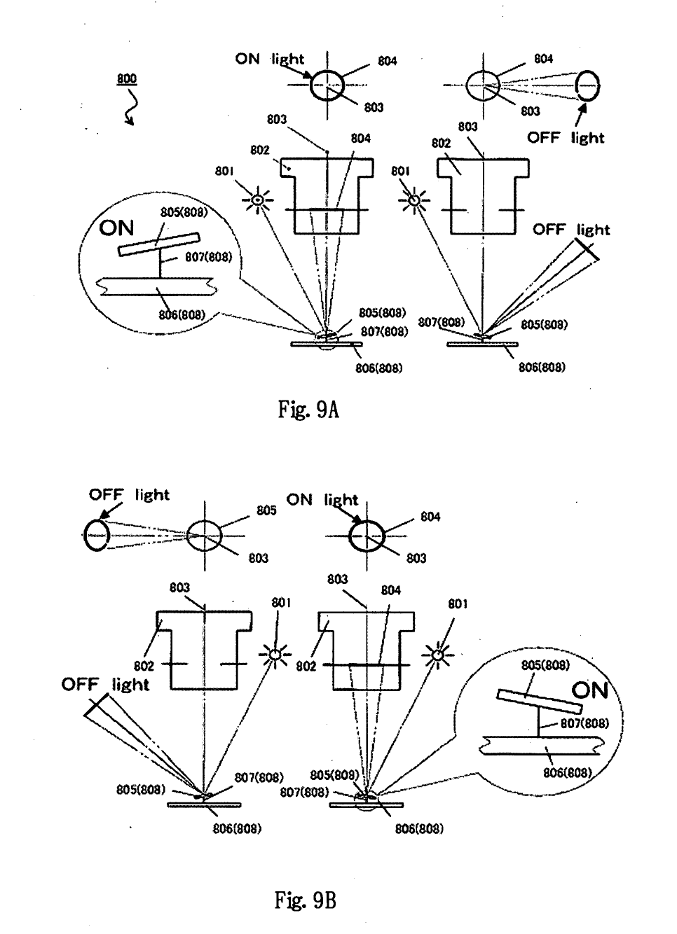

FIGS. 9A and 9B are schematic diagrams of image display system to illustrate an increased freedom of an optical system design because of using the above described mirror device. FIGS. 9A and 9B show a display apparatus includes a light source 801, a projection lens 802, and a mirror device 808 described above. FIGS. 9A and 9B specifically show a mirror 805 of the mirror device 808, an elastic hinge 807 supporting the mirror 805, and a substrate 806 supporting the elastic hinge 807. Particular details are also shown to delineate in a manner that the central optical axis of the ON light reflected on the mirror 805 enters the center axis 803 of the iris 804 of the projection lens 802.

FIG. 9A shows schematic configuration of the display apparatus that includes the mirror device described above and a projection lens 802 with the light source 801 projected from the left side. The right drawing of FIG. 9A shows the mirror 805 inclining to a position to project an OFF light, thus making the light from the light source 801 away from the iris 804 of the projection lens. Conversely, the left drawing of FIG. 9A shows the mirror 805 inclining to a position to project an ON light, thus transmitting the light from the light source 801 to enter into the iris 804 of the projection lens.

The mirror device 808 according to the operational principles described above enables a discretionary selection of the deflection axis of the mirror 805 and the deflection direction. There is additional freedom for setting the directions of the ON light and OFF light.

FIG. 9B shows schematic configuration of a display apparatus similar to the configuration of FIG. 9A with the light source 801 projecting an illumination light on the right side. The left drawing of FIG. 9B shows a light source 801 that is disposed on the right side and the mirror 805 inclining to a position to project an OFF light. The light transmitted from the light source 801 is projected away from the iris 804 of the projection lens. Conversely, the right drawing of FIG. 9B shows the light source 801 disposed on the right side and the mirror 805 that is inclined to a position to project an ON light, thus transmitting the light from the light source 801 to enter into the iris 804 of the projection lens.

Therefore, the conventional display system requires separate mirror devices in the cases of placing a light source on the left and of placing it on the right. There is no freedom to select the deflection axis or the deflection direction of the mirror. In comparison, the present embodiment allows a discretionary positioning of a light source because of the capability of selecting the deflection axis of a mirror and the deflection direction thereof for a mirror device. Accordingly, the use of the mirror device described above increases the degree of freedom in a structure design of a display apparatus. The mirror device described above allows a free selection of the deflection axis, the deflection direction of the mirror. The invention further discloses the inversion of an image display, thereby enabling an elimination of an extraneous optical element. The display system disclosed by this invention enables the production of a more compact display apparatus and a reduction of production cost. It is further noted that the present invention can be changed in various manners possible within the scopes and should not limited by the configurations exemplified in the embodiments described above.

Although the present invention has been described by exemplifying the presently preferred embodiments, it shall be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as falling within the true spirit and scope of the invention.

What is claimed is:

1. A display apparatus comprising:
a plurality of mirror devices each including plural deflectable mirrors for modulating and reflecting an incident light to different angular directions wherein at least one of said deflectable mirrors is controllable to change to a different direction than a deflection axis of other deflectable mirrors.

2. The display apparatus according to claim 1, further comprising:
a color separator including a color separation filter for separating the incident light by reflecting a light of a specific wavelength; and
a color synthesizer for synthesizing lights of different wavelengths.

3. The display apparatus according to claim 1, further comprising
a projecting optical system for projecting a light modulated by said deflectable mirrors projected to an ON angular direction for displaying an image.

4. The display apparatus according to claim 1, wherein:
at least one of said plurality of mirror devices projecting a display image different from images displayed by other mirror devices.

5. A display apparatus comprising:
a plurality of mirror devices each including a plural deflectable mirrors for modulating and reflecting an incident light to different angular directions; and
a controller for controlling and operating at least one of said deflectable mirrors is controllable to change to a different direction than a deflection axis of other deflectable mirrors.

6. The display apparatus according to claim 5, further comprising:
a color separator including a color separation filter for separating the incident light by reflecting a light of a specific wavelength, and
a color synthesizer for synthesizing lights of different wavelengths.

7. The display apparatus according to claim 5, wherein:
a projecting optical system for projecting a light modulated by said deflectable mirrors projected to an ON angular direction for displaying an image.

8. The display apparatus according to claim 5, wherein:
at least one of said plurality of mirror devices projecting a display image different from images displayed by other mirror devices.

9. A mirror device, comprising:
a plurality of deflectable mirrors each modulating and reflecting an incident light to different angular directions, and
a controller for controlling and changing over a direction of at least a deflection axis of a deflectable mirror and/or a deflection direction of the deflectable mirrors.

10. The mirror device according to claim 9, wherein:
the plurality of deflectable mirrors each having an approximate square shape and arranged in an array parallel with one another in a same direction, and
the deflection axis of each of the mirrors is disposed on a two diagonal lines of said approximate square shape.

11. The mirror device according to claim 9, wherein:
the controller applying a voltage to at least one of a plurality of electrodes disposed under said deflectable mirrors for controlling the deflection axis of the deflectable mirrors and/or the deflection direction thereof.

12. The mirror device according to claim 9, wherein:
said controller further selecting a block of said deflectable mirrors for controlling and selectively changing the direction of the deflection axis of the deflectable mirrors.

13. The mirror device according to claim 9, wherein:
said controller further selecting a block of said deflectable mirrors for controlling and selectively changing the deflection direction of the deflectable mirrors.

14. A display apparatus comprising:
a mirror device comprising a plurality of deflectable mirrors for modulating and reflecting an incident light to direction angular directions;
a controller for controlling and changing over a direction of at least a deflection axis of a deflectable mirror and/or a deflection direction of the deflectable mirrors; and
a projecting optical system for projecting a light modulated by said deflectable mirrors projected to an ON angular direction for displaying an image.

15. A mirror device supported on a substrate comprising a plurality of mirror arrays each including plural deflectable mirrors for modulating and reflecting an incident light to different angular directions wherein:
each of said deflectable mirrors having a deflectable hinge and being flexibly controllable to adjust to different directions of a deflection axis among each of the plurality of deflectable mirrors.

16. The mirror device according to claim 15, wherein:
the plural deflectable mirrors each having an approximate square shape and arranged in an array parallel with one another in a same direction, and
the deflection axis of each of the mirror is disposed on a two diagonal lines of said approximate square shape.

17. The mirror device according to claim 15, wherein:
at least one of said plurality of mirror devices projecting a display an image different from images displayed by other mirror devices.

18. A mirror device supported on a substrate comprising a plurality of mirror arrays each including plural deflectable mirrors for modulating and reflecting an incident light to different angular directions, comprising:
a controller for transmitting an image signal to each of the mirror arrays wherein a deflection direction of the deflectable mirrors for reflecting the incident light to an ON direction of at least one mirror array for image display is different from a deflection direction of other mirror arrays for reflecting the incident light to said ON direction for image display.

19. The mirror device according to claim 18, wherein:
at least one of said plurality of mirror arrays projecting a display image different from images displayed by other mirror arrays.
